(19) United States
(12) Patent Application Publication
(10) Pub. No.: US 2024/0146729 A1
(43) Pub. Date: May 2, 2024

(54) AUTHORIZATION FRAMEWORK FOR APPLICATION PROGRAMMING INTERFACE (API) COLLECTIONS

(71) Applicant: T-Mobile USA, Inc., Bellevue, WA (US)

(72) Inventors: Sohan Bhambu, Bellevue, WA (US); Senthil Velusamy, Bellevue, WA (US); Justin David Thoreson, Bellevue, WA (US)

(21) Appl. No.: 17/979,677

(22) Filed: Nov. 2, 2022

(51) Int. Cl. H04L 9/40; G06F 9/54

(52) U.S. Cl. CPC H04L 63/0884; G06F 9/547; H04L 63/0853; H04L 63/102

(57) ABSTRACT

Aspects of the disclosure relate to assessing authorization control of application programming interfaces (APIs) for services and/or microservices. Implementations disclosed herein robustly identify APIs configured with sufficient authorization control and APIs configured with insufficient authorization control. As such, disclosed implementations streamline a secure software development life cycle. Operations performed in example implementations include obtaining an identity token from an identity management module and invoking an API with multiple queries. At least one of the queries includes payload values specific to an identity different than an identity represented by the identity token. Responses of the API to the multiple queries are used to determine whether the API is configured with sufficient authorization control, and based on the determination, various post-assessment operations can be performed.

### BACKGROUND

In a service-oriented architecture, discrete services operate individually and in a modular manner to serve users. Data output by example services can be user-sensitive. Accordingly, security related to a service context includes ensuring that user-specific and sensitive data is handled and distributed by a service appropriately.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a diagram that illustrates authentication and authorization domains within a microservice architecture or environment.

FIG. 4 is a block diagram that illustrates an example framework for authorization testing of APIs of services.

FIG. 5 is a sequence diagram that illustrates example operations related to authorization testing of APIs.

FIG. 6 illustrates definition of APIs in an example repository according to platforms or services associated with the APIs.

FIG. 7 illustrates example testing metadata associated with APIs.

FIG. 8 illustrates variations of example API query values for authorization testing of APIs.

FIG. 9 illustrates an example user interface for indicating test results and authorization measures for APIs.

FIG. 10 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to testing service security, and more particularly, to testing authorization security control for application programming interfaces (APIs) via which users interact with software services. The technology can be implemented in a development stage of APIs for a service-oriented platform, and secure APIs (at least with respect to authorization) that are identified via the technology can be automatically provided for use in a production or externally-facing environment.

Protecting users from malicious and accidental access to user-specific data is critical. APIs provide access to sensitive data, functions, and capabilities, and thus, APIs are a vulnerability point for attackers who intend to maliciously manipulate and access user-specific services and data. Accordingly, APIs need security controls to protect users, and these security controls generally relate to authentication (verifying identity) and/or authorization (verifying access rights or permissions). Insufficient authorization control, even given sufficient authentication control, leaves significant security risks.

Implementations disclosed herein address various challenges in assessing authorization control of APIs. For example, APIs can be configured according to many different architectures (e.g., RESTful, SOAP, XML-RPC) for a variety of common data protocols (e.g., JSON, XML, YAML) over a variety of different communication protocols (Ethernet, IP, TCP, UDP, HTTP, HTTPS, HTTP/2, WebSocket). Further, APIs can be implemented in a variety of different situations (e.g., public APIs, private APIs, internal APIs, third-party APIs) and may relate to a variety of different services or applications (e.g., mobile applications, web applications, Internet-of-Things (IoT) applications). Another technical challenge is that, while some authorization attacks are known and have identifiable signatures that can be reproduced in testing, other unknown attacks exist. Authorizations can also vary per the user who is requesting access to the resources.

With many variables, each unique API has unique vulnerabilities to different attacks from different sources. Implementations disclosed herein address at least these technical challenges by providing a scalable framework for assessing APIs that is agnostic to specific architectures and protocols. Collections of APIs that include different varieties of APIs can be assessed for authorization control indiscriminately. As such, implementations disclosed herein can streamline a development process by enabling improved identification of security deficiencies. In example implementations, a given API is assessed over multiple iterations of tests to determine robust results that describe whether the given API is configured with sufficient or insufficient authorization control.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Exemplary Wireless Communications System

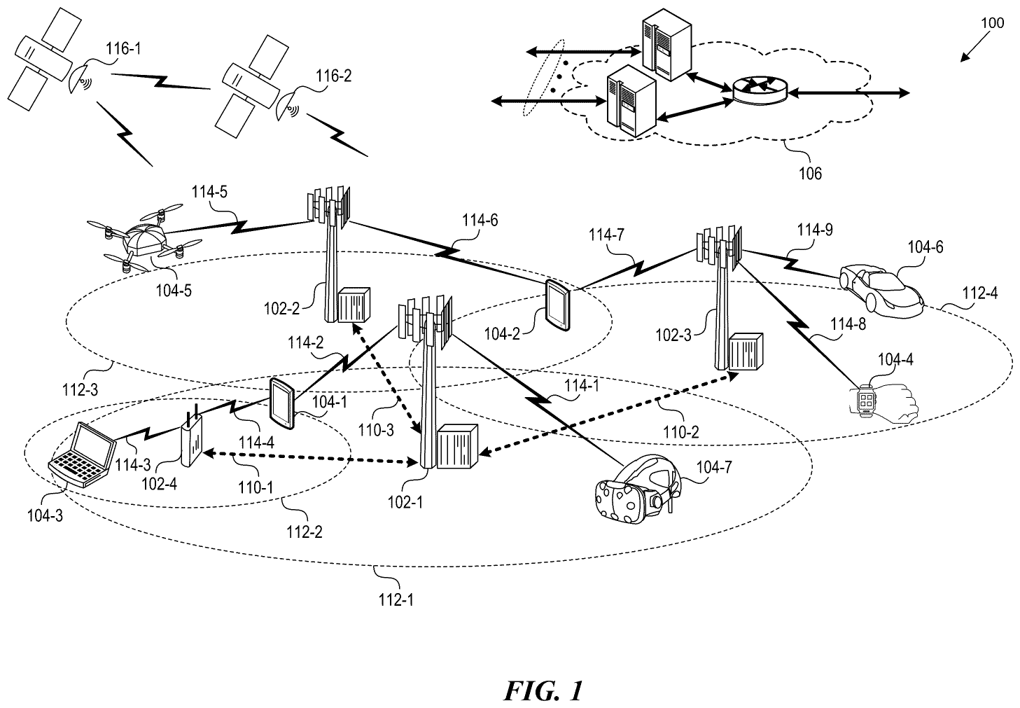

FIG. 1 is a block diagram that illustrates a wireless telecommunication network 100 in which aspects of the disclosed technology are incorporated. For example, users can transmit API queries (e.g., calls, requests, invocations, and/or the like) to APIs via the wireless telecommunication network 100 in order to interface with services (or microservices) of a platform. Similarly, an API can return response data to a system from which a query was received via the wireless telecommunication network 100, in some examples. In a services- or microservices-oriented architecture, different services can be distributed across different computing systems and interact with respective APIs via the wireless telecommunication network 100 to fulfill a user request.

The wireless telecommunication network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The wireless telecommunication network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of the wireless telecommunication network 100 also include wireless devices 104-1 through 104-7 (referred to individually as “wireless device 104” or collectively as “wireless devices 104”) and a core network 106. The wireless devices 104-1 through 104-7 can correspond to or include network entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The wireless telecommunication network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The wireless telecommunication network 100 can include a 5G network and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The wireless telecommunication network 100 can thus form a heterogeneous network in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the wireless telecommunication network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the wireless telecommunication network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (ARNR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network equipment at the edge of the wireless telecommunication network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in wireless telecommunication network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the wireless telecommunication network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the wireless telecommunication network 100 implements 6G technologies including increased densification or diversification of network nodes. The wireless telecommunication network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the wireless telecommunication network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the wireless telecommunication network 100 can implement a converged Radio Access Network (RAN) and Core architecture to achieve Control and User Plane Separation (CUPS) and achieve extremely low User Plane latency. In yet another example of 6G, the wireless telecommunication network 100 can implement a converged Wi-Fi and Core architecture to increase and improve indoor coverage.

### Exemplary 5G Core Network Functions

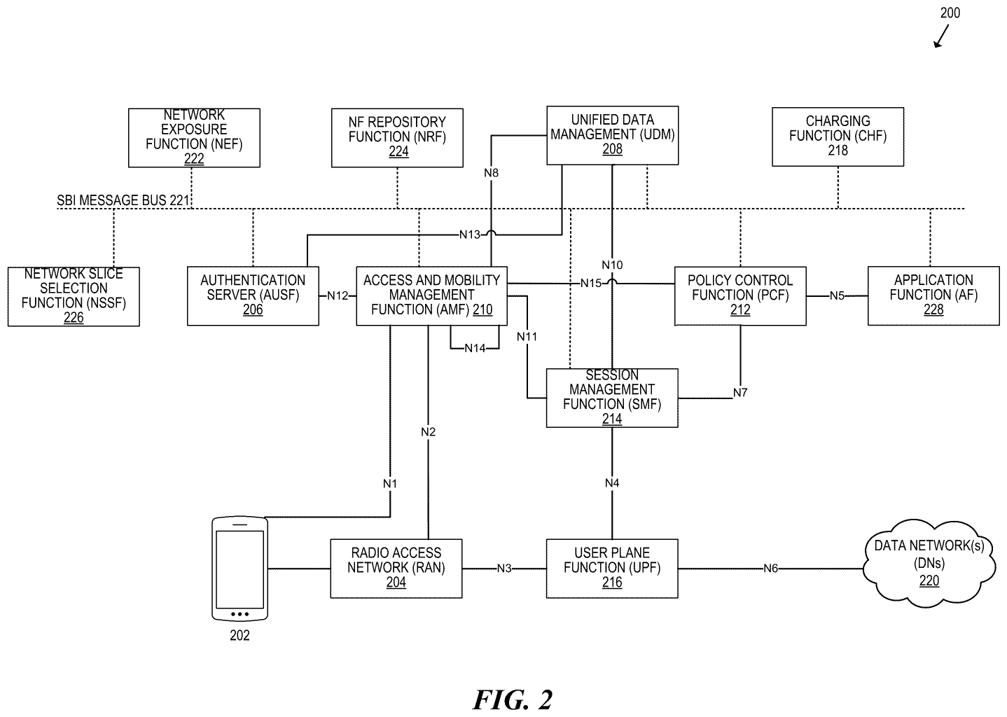

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, a NF Repository Function (NRF) 224 a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, service-level agreements, and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS), to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make-up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224, use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical QoS and charging rules, includes Network Slice selection, which is regulated by the NSSF 226.

### Exemplary Frameworks for Authorization Testing

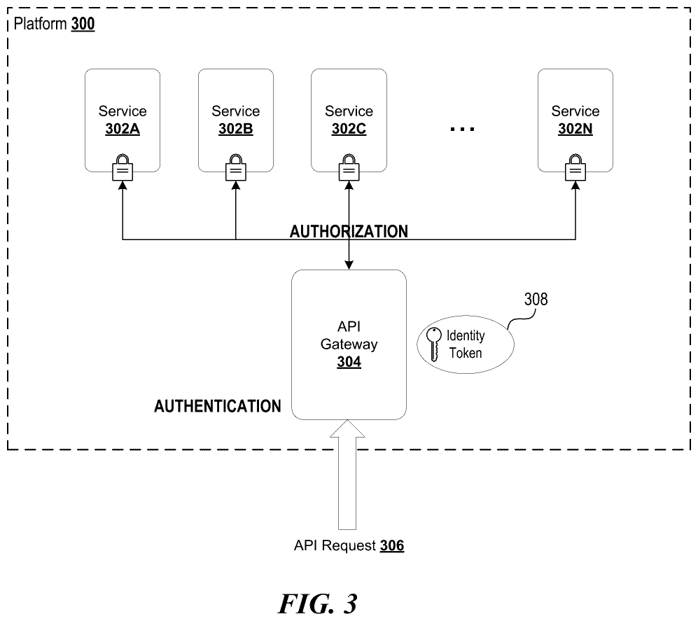

FIG. 3 is a block diagram that illustrates an example service-oriented platform 300 that includes a plurality of services (e.g., service 302A, service 302B, service 302C, service 302N, collectively referred to as services 302) with which a user can interact. In particular, a user can query a service via an API of the service to request user-specific data from the service. For example, the user provides user-specific data as an input to the service via the API, and the service performs a function with the input to provide an output that is returned by the API.

In particular, according to some implementations, the service-oriented platform 300 includes an API gateway 304 at which API requests 306 are received and then distributed to a target service. In some implementations, an API request 306 includes an identity token 308 that represents the identity of the user (from which the API request 306 originates) and input or payload data to be provided to the target service. For example, the input or payload data represents parameters and data to be used by the target service to fulfill a requested task

As illustrated in FIG. 3, authentication of a user identity indicated by the API request 306 can occur at the API gateway 304 or where the user interfaces with the platform 300. Authentication includes verifying the identity token 308 included in the API request 306 such that the service-oriented platform 300 can determine and verify who sent the API request 306. As further illustrated, authorization security is relevant as the API request 306 is passed to a target service (e.g., one of the services 302). In particular, authorization security relates to whether the API request 306 is valid and is allowed to use and access the target service. With insufficient authorization control, the API for the target service can return data specific to a different user to the user from which the API request 306 originates, leading to security breaches and threats. With sufficient authorization control, however, the API for the target service is expected to return an error or deny the request.

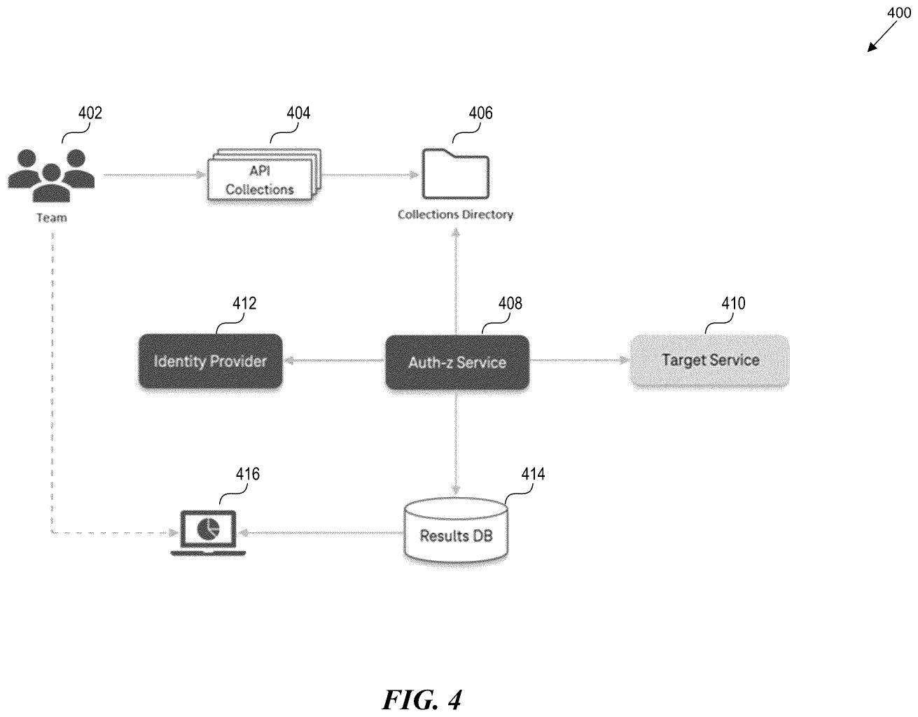

FIG. 4 illustrates an example of a framework 400 for assessing authorization control of APIs, such as APIs for the services 302 of a service-oriented platform 300. For example, the framework 400 illustrated in FIG. 4 can be implemented for the service-oriented platform 300 of FIG. 3 to prevent authorization attacks on the services 302, to mitigate accidental authorization breaches of the services 302, and/or the like. Generally, the framework involves iterated testing of an API with different variations of API requests and observing whether the API returns user data when expected and when unexpected.

With the framework 400, one or more users 402 develop and upload API collections 404 to a repository 406. An API collection 404 includes one or more individual APIs, and in some implementations, the APIs of an API collection 404 relate to a particular service and/or service-oriented platform. In some implementations, APIs of an API collection 404 are defined with a respective specification, data protocol, communication protocol, and/or the like; thus, in some examples, API requests or queries for different APIs of an API collection 404 can differ with respect to format, structure, and data inputs. In some implementations, the framework exists in a software development life cycle (SDLC) by which the users 402 operate and develop software implementations for functions, services, platforms, and interfaces. In some implementations, the repository 406 is a platform for the users 402 to design, develop, and build the API collections 404 (e.g., a Postman API platform).

In some implementations, the repository 406 is configured to store and indicate API collections 404 according to an organizational hierarchy. For example, the API collections 404 are organized within the repository 406 according to the platform or service to which the API collections 404 relate.

As illustrated in FIG. 4, the framework 400 includes an authorization service 408 (also understood as an authorization module, an assessment service/module, a test service/module, and/or a test-execution service/module), and the authorization service 408 is configured to assess authorization control of the API collections 404 developed by the users 402. In some implementations, the authorization service 408 resides within a particular platform for which the API collections 404 are developed and can interact within the particular platform with various services 302 to which the APIs of the API collections 404 correspond. In some implementations, the authorization services 408 resides outside of any particular platform. In some implementations, the authorization service 408 is configured to invoke a target service 410 (e.g., one of the services 302 of the service-oriented platform 300, a service module that manages user data and performs user-specific functions/tasks) via an API developed for the target service 410 to test whether the API is configured with sufficient authorization control. In the course of assessing the APIs of a given API collection 404, the authorization service 408 can interact with multiple target services 410 with which the APIs correspond.

To assess a particular API for a particular target service, the authorization service 408 is configured to generate multiple queries that are used to iteratively invoke the particular API. In an example implementation, the authorization service 408 includes a query-generation module configured to generate the queries used to iteratively invoke an API under test. In some implementations, some of the multiple queries are variations (e.g., fuzzed variations) of each other, and the authorization service 408 is configured to perform fuzzing operations. In particular, the authorization service 408 modifies or fuzzes user-specific payload values of an API query for the particular API to values that are specific to different user identities, and in particular, user identities that are different than that represented by an identity token included in the API query. The authorization service 408 then generates test results based on observing responses of the particular API to the different queries and comparing the observed responses to expected responses. In an example implementation, the authorization service 408 includes a test-execution module configured to invoke an API under test with queries and to determine test results based on responses of the API to the queries.

The authorization service 408 interacts with an identity service 412 (also referred to as an identity provider, an identity module, an identity and access management (IAM) service/module) to request and obtain identity tokens to include in API queries used by the authorization service 408 to invoke a particular API under test. The identity service 412 is configured to perform identity-related operations including generating an identity token to represent a particular user or user identity, verify validity of a given identity token, and/or the like. In some implementations, the framework 400 includes a plurality of identity services 412 that manage different types of identity tokens, including JSON Web Tokens, One-Time Password (OTP) Tokens, hardware tokens, OAuth Tokens, and/or the like. In some implementations, the authorization service 408 selects a particular identity service 412 that is relevant to the platform and/or the service whose API is under test.

The framework 400 further includes a results database 414 coupled to the authorization service 408. In some implementations, the results database 414 stores test result generated by the authorization service 408 when the authorization service 408 iteratively invokes APIs with different queries. In some implementations, the results database 414 is a structured query language (SQL) database. In some implementations, the results database 414 stores authorization classifications (e.g., pass, fail, sufficient, insufficient) for each API of an API collection 404 tested by the authorization service 408, collection-wide measures (e.g., percentage of APIs with sufficient authorization control), and/or the like.

From the results database 414, an assessment dashboard 416 can be provided for display to the users 402. In an example implementation, the authorization service 408 includes a display module configured to store the test results in the results database 414 and cause display of the assessment dashboard 416. In particular, test results for the APIs and aggregated analysis and measures thereof can be displayed to the team of users 402. By the benefit of the assessment dashboard 416, the users 402 can revise the APIs in the repository 406 to add and/or improve authorization control of the API collections 404. Accordingly, a development feedback loop can be provided by the framework 400. In some implementations, authorization assessment (e.g., by the authorization service 408 of the framework 400) can be periodically performed on APIs stored at the repository 406, or performed ad-hoc or on request by the users 402, or triggered based on certain events. Thus, the framework 400 provides an approach of testing collections of APIs to verify that the invoked APIs return the correct and expected responses, in some implementations.

### Exemplary Operations for Authorization Testing

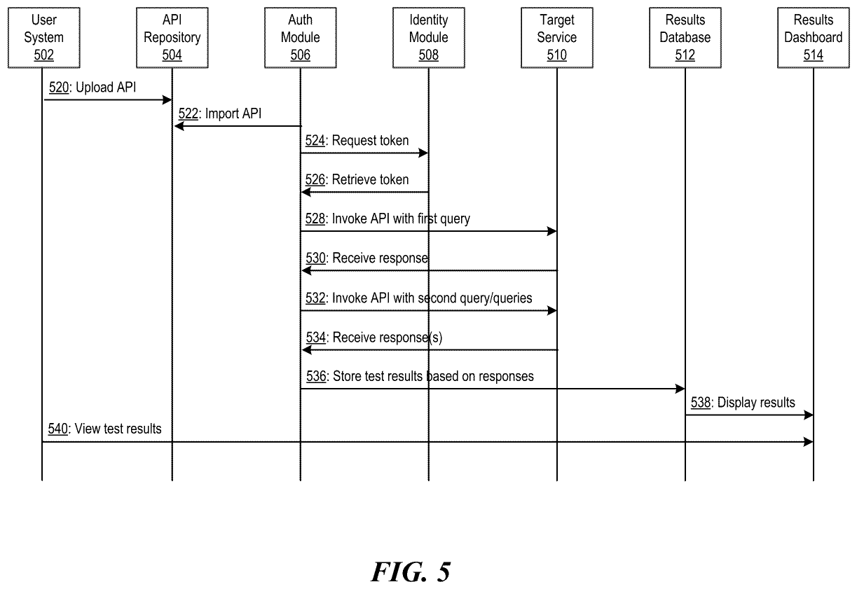

FIG. 5 illustrates a sequence diagram that includes example operations for assessing authorization controls for APIs. According to the sequence diagram, APIs are assessed for authorization controls in a scalable manner and during a SDLC before the APIs are deployed for operation/use, in some implementations. In an example implementation, the sequence diagram of FIG. 5 is implemented within the framework 400 illustrated in FIG. 4.

At 520, one or more user systems 502 develop and upload API collections to an API repository 504. In some implementations, the user systems 502 are associated with different teams and/or organizations, and the API repository 504 stores the API collections according to the respective organizations associated with the user systems 502. In some implementations, a user system 502 uploads an API collection (one or more APIs) to a particular portion of or location within the API repository 504 based on the organization to which the user system 502 and/or users of the user system 502 belong.

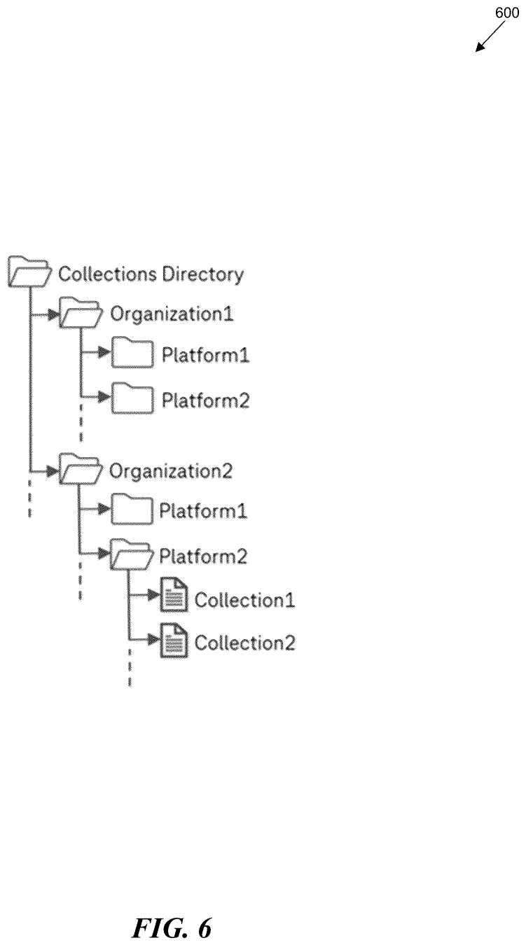

FIG. 6 illustrates an organizational hierarchy 600 by which API collections are uploaded to and stored by the API repository 504. In the illustrated example, the organizational hierarchy 600 defines, at a first level, multiple organizations (e.g., teams, entities, user groups) with which user systems 502 that upload API collections are associated. Further, the organizational hierarchy 600 defines, at a second level, multiple platforms for which the API collections are configured. Thus, according to the organizational hierarchy 600, a given API collection uploaded by a given user system and developed for a given platform is sorted within the API repository 504 according to each of the two dimensions (organization and platform). By doing so, API collections can be sorted and defined within the API repository 504 such that large volumes of APIs can be tested in an organized and segmented manner.

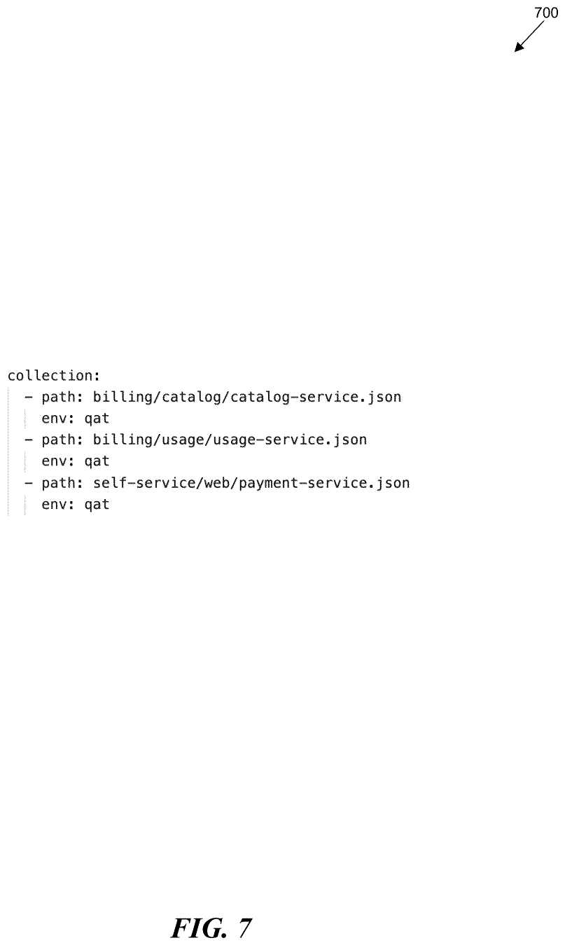

In some implementations, the API repository 504 further indicates testing or assessment metadata for each API collection. In some examples, the user system 502 indicates the testing or assessment metadata while uploading an API collection. FIG. 7 illustrates an example of testing or assessment metadata 700. In some implementations, the assessment metadata 700 indicates or specifies an environment in which APIs of an API collection are to be tested. Thus, with the assessment metadata 700, assessment of APIs is performed in specific environmental conditions, contexts, and scenarios.

In some examples, the assessment metadata 700 indicates an on-premises environment (e.g., onprem), a Software-as-a-Service (e.g., onprem) environment, an exposed environment, a production environment, and/or the like for testing a given API. In the illustrated example of assessment metadata 700, the environment is specified underneath a path that specifies the given API. In some implementations, the assessment metadata 700 is configured as a .yml file. In some implementations, the assessment metadata 700 further indicates other testing parameters, such as a frequency at which the APIs of the collection are routinely tested (e.g., every two weeks, monthly, once per quarter, annually).

Returning to FIG. 5, at 522, an authorization module 506 retrieves, imports, copies, and/or the like one or more APIs stored at the API repository 504. In some implementations, the authorization module 506 detects the uploading of an API collection to the API repository and begins the assessment process by retrieving the API collection from the API repository. In some implementations, the authorization module 506 detects an update or change to an API collection stored in the API repository 504 and retrieves the API collection for assessment. In some implementations, the authorization module 506 routinely and periodically retrieves an API collection for assessment (e.g., according to a frequency defined by assessment metadata 700 associated with the API collection). In some implementations, the authorization module 506 retrieves a particular API collection according to the organizational hierarchy 600 of the API repository 504. For example, different platforms are associated with different testing priorities, and the authorization module 506 retrieves API collections stored under a particular platform indicated by the organizational hierarchy 600 according to the testing priorities.

At 524, an authorization module 506 requests an identity token from an identity module 508. In some implementations, the authorization module 506 requests an identity token for a test user identity. In some implementations, the API collection or the API under test is configured for a target service 510 or a platform that uses a specific identity module out of a plurality of identity modules. Thus, the authorization module 506 requests the identity token from an appropriate identity module according to the API collection under test.

At 526, the authorization module 506 retrieves or receives the identity token from the identity module 508. With the identity token, the authorization module 506 can generate queries for invoking the API collection or API under test.

At 528, the authorization module 506 invokes an API under test for a target service 510 with a first query. The first query includes the identity token and a payload, and the payload includes input data used by the target service 510 to fulfill a user-specific task or function. In some implementations, the payload includes one or more user-specific values, and in particular, the authorization module 506 populates the payload of the first query with values that are specific to the test user identity represented by the identity token. Due to the consistency in user identity associated with the payload values and the identity token, the authorization module 506 expects that no authorization error will be indicated by the API, because the authorization module 506 expects that the test user identity is authorized to use its own user-specific data with the target service 510.

At 530, the authorization module 506 receives a response via the API under test from the target service 510 in response to the first query. In some implementations, the authorization module 506 determines a first test result based on whether the response returned by the API is expected. For example, the first test result is positive when the API returns user data specific to the test user identity, a status 200 OK code, and/or the like. For example, the first test result is negative when the API does not return user data, a status 200 OK code, and/or the like. In some implementations, a first test result that is negative suggests that the API is not able to verify the identity token (despite the identity token being authentic and valid as provided by the identity module 508).

At 532, the authorization module 506 invokes the target service 510 via the API with one or more second queries. In some implementations, the second queries are fuzzed modifications or variations of the first query. The authorization module 506 generates each second query to include the same identity token as the first query, but the authorization module 506 includes a modified version or variation of one of the user-specific payload/input values in each second query.

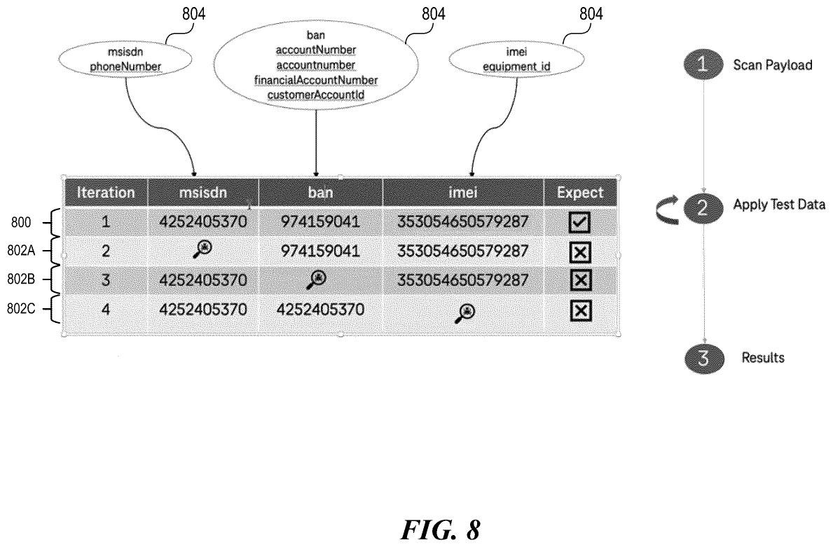

FIG. 8 illustrates example implementations related to the authorization module 506 generating second queries and invoking the API with the second queries. In particular, FIG. 8 illustrates examples of second queries 802 (collectively referring to second queries 802A, 802B, and 802C) that are modified from a first query 800. In the illustrated example, the first query 800 and the second queries 802 are configured for the API under test and are structured to include at least three user-specific input values or user-specific payload values 804. For example, the user-specific payload values 804 include a phone number value, an account number, and an equipment identifier that is used by the target service 510 to perform a user-specific task or function. In some implementations, the user-specific payload values 804 are identified based on scanning a query structure that is specified for the API under test. In some implementations, the authorization module 506 is configured to scan for different variations of field names that specify user-specific payload values 804. That is, the authorization module 506 is configured to flexibly identify user-specific portions of a query payload, allowing the authorization module 506 to generate queries for APIs configured with different specifications, structures, protocols, and/or the like.

Then, test data is applied to each of the first query 800 and the second queries 802. As discussed above, the first query 800 includes payload values that are specific to the test user identity represented by the identity token included in the first query 800. Each of the second queries 802 includes a modification of one of the user-specific payload values 804. For example, the second query 802A includes a modification, a fuzz, or a variation of the phone number payload value, while the other payload values 804 are kept the same. The second query 802B includes a modification of the account number payload value, and the second query 802C includes a modification of the equipment identifier payload value. In some implementations, the modification of a user-specific payload value in a given second query 802 is specifically a value that is specific to a user identity that is different than the test user identity represented by the identity token included in each query. For example, to generate the second query 802A, the authorization module 506 selects a different user identity and obtains a phone number value specific to the different user identity to use in the second query 802A in the place of the phone number value of the test user identity (e.g., 4252405370 in the illustrated example). Because each second query 802 includes user-specific data that the test user identity is not expected to be authorized to use, the authorization module 506 expects to receive an authorization error or denial from the API under test in response to each second query 802.

Returning to FIG. 5, at 534, the authorization module 506 receives one or more responses from the API under test in response to the one or more second queries. As discussed, the authorization module 506 expects to receive an error or denial (e.g., a level 4xx error or status code) from the API in response to each of the second queries. Accordingly, the authorization module 506 determines a second test result for each invocation of the API under test based on whether unexpected user data is received. The second test result is positive if the expected error or denial is received from the API. The second test result is negative if the user data for the test user identity and/or the different user identity is received from the API.

At 536, the authorization module 506 stores test results based on the responses received from the API under test of the target service 510 (e.g., at operations 530 and 534) at a results database 512. In some implementations, the authorization module 506 further stores authorization measures or classifications for each API under test that are determined based on the test results. For example, an API is classified as vulnerable if any of the test results are negative.

At 538, the results database 512 provides the test results to a results dashboard 514 for display. For example, a dashboard or display module reads data imported from the In some implementations, a dashboard or display module will read data imported from the results database 512 to generate a dashboard. An example dashboard includes statistical summaries and graphical visualizations of the test results, and the dashboard or display module is configured to determine statistical summaries of the test results. An example dashboard organizes test results by organization, platforms, services, and APIs, for example, to show a number of vulnerable APIs within each organization and each platform. In some implementations, the results database 512 sorts the test results according to the same organization hierarchy as the API repository 504. At 540, the user system 502 accesses or is provided with the results dashboard 514 such that users of the user system 502 views the test results.

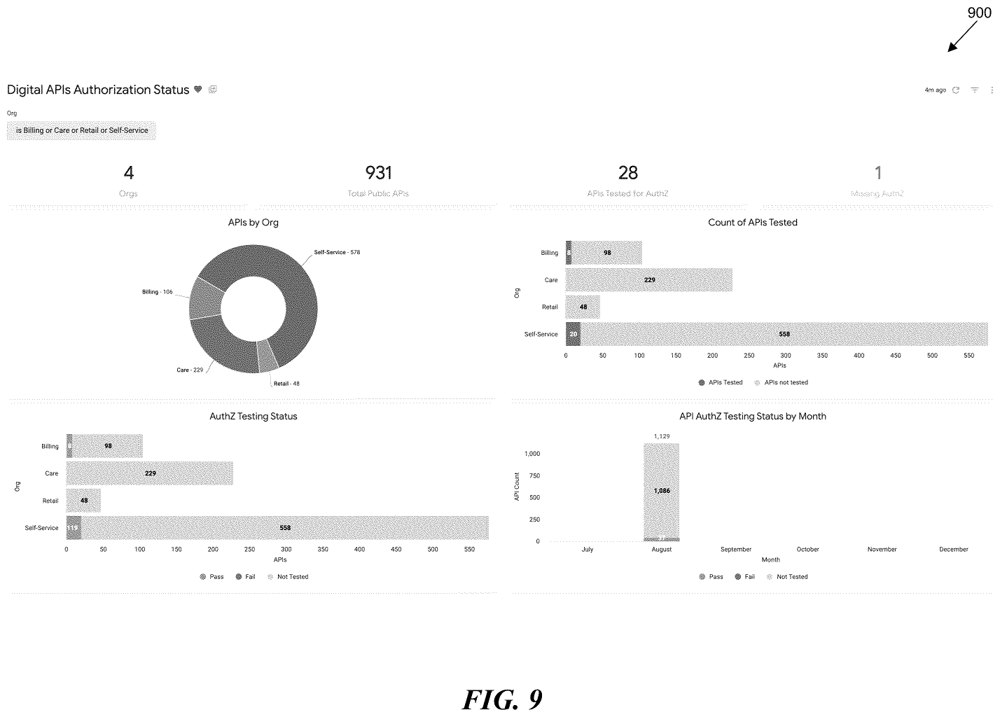

FIG. 9 illustrates an example user interface 900 via which users can view test results indicating authorization control and vulnerability of assessed APIs. In the illustrated example, the user interface 900 includes graphical visualizations of a number of vulnerable APIs, or APIs configured with insufficient authorization control, on an organization and/or a platform basis. Further, in the illustrated example, the user interface 900 indicates a number of vulnerable APIs with respect to the gateway used by each API. In some embodiments, a user interface indicates a proportion, ratio, or percentage of total APIs that are vulnerable. In some embodiments, a user interface includes graphical visualizations that describe authorization vulnerability of APIs over time. Accordingly, users can see that authorization issues of APIs have been addressed and fixed over time.

In some implementations, to provide further support in a SDLC, the authorization module 506 generates a report and/or a user interface that indicates, for a vulnerable API, the fuzzed or modified values of the second queries caused the vulnerable API to return unexpected responses. Accordingly, for example, a developer or user can see that the vulnerable API does not adequately verify that the test user identity is authorized to use another user's phone number for the target service 510. Similarly, the report and/or user interface indicates the different user identities to which payload values in the second queries are modified. Accordingly, for example, a developer or user can see that the vulnerable API erroneously allows the test user identity to use a phone number of a different user identity specifically.

In some implementations, the authorization module 506 automatically deploys non-vulnerable APIs for operation/use. In some implementations, the authorization module 506 passes the non-vulnerable APIs for further downstream testing.

Thus, according to the sequence diagram illustrated in FIG. 5, an API can be assessed with respect to authorization security and control. Multiple APIs can be assessed in the same manner, and in some implementations, the authorization module 506 reads multiple APIs or API collections in sequential order. In some implementations, API collections are assessed in a particular order to improve efficiency. For example, API collections belonging to the same platform (as indicated by the organizational hierarchy of the API repository 504) can be tested together or sequentially, such that the authorization module 506 can use the same identity token for assessing the API collections.

### Exemplary Computing System

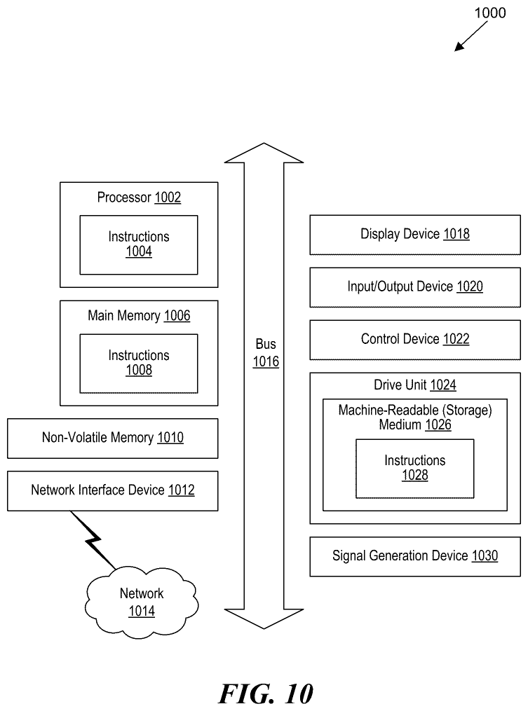

FIG. 10 is a block diagram that illustrates an example of a computing system 1000 in which at least some operations described herein can be implemented. In some examples, the computing system 1000 implements at least some of the components of the service-oriented platform 300 of FIG. 3. In some examples, the computing system 1000 implements the authorization service 408 illustrated in FIG. 4. In some examples, the computing system 1000 implements the authorization module 506 illustrated in FIG. 5. In some examples, the computing system 1000 is one of a plurality of distributed computing systems that together implement any one or more of the service-oriented platform 300 illustrated in FIG. 3, the authorization service 408 illustrated in FIG. 4, and the authorization module 506 illustrated in FIG. 5.

As shown, the computing system 1000 can include: one or more processors 1002, main memory 1006, non-volatile memory 1010, a network interface device 1012, video display device 1018, an input/output device 1020, a control device 1022 (e.g., keyboard and pointing device), a drive unit 1024 that includes a storage medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computing system 1000 is intended to illustrate a hardware device on which components illustrated or described relative to the examples of the figures and any other components described in this specification can be implemented.

The computing system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementation, the computing system 1000 can be an embedded computer system, a system-on-chip (SOC), a single-board computer system (SBC) or a distributed system such as a mesh of computer systems or include one or more cloud components in one or more networks. Where appropriate, one or more computer systems 1000 can perform operations in real-time, near real-time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable (storage) medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. At least one non-transitory computer-readable storage medium storing instructions that, when executed by at least one data processor of a system, cause the system to:
detect, in a repository, an addition of an application programming interface (API) that corresponds to a service of a platform;
in response to detecting the addition of the API, obtain, from an identity management module of the platform, an identity token that represents a particular user who is authenticated on the platform;
perform a first authorization test that includes invoking the API with a first query that includes: (i) the identity token and (ii) one or more payload values specific to the particular user,
wherein performing the first authorization test includes determining a first test result that indicates whether expected user data for the particular user is returned by the API in response to the first query;
generate one or more second queries for the API that each include: (i) the identity token and (ii) a modified value of the one or more payload values specific to the particular user;
perform a plurality of second authorization tests by invoking the API with each of the one or more second queries,
wherein performing the plurality of second authorization tests includes determining one or more second test results each indicating whether unexpected user data is returned by the API in response to a respective second query; and
cause, at a display interface associated with the platform, display of an authorization measure for the API that is based on the first test result and the one or more second test results.

2. The at least one non-transitory computer-readable storage medium of claim 1, wherein the modified value is specific to a second user that is different than the particular user.

3. The at least one non-transitory computer-readable storage medium of claim 1, wherein each second test result is a positive result in response to the API returning an error, and wherein each second test result is a negative result in response to the API returning user data associated with the particular user or with a second user that is different than the particular user.

4. The at least one non-transitory computer-readable storage medium of claim 1, wherein the instructions further cause the system to:
in response to a given second test result being a negative result, generate a report that indicates the modified value of the respective second query.

5. The at least one non-transitory computer-readable storage medium of claim 1, wherein the API is stored in the repository with metadata that indicates an environment in which the API is invoked for the first authorization test and the plurality of second authorization tests.

6. A system for authorization testing of APIs, the system comprising:
a query-generation module configured to generate, for each API of a collection of APIs, a first query and one or more second queries,
wherein the first query includes: (i) an authenticated token for the collection of APIs, and (ii) one or more payload values that are specific to an identity represented by the authenticated token,
wherein the one or more second queries each include: (i) the authenticated token, and (ii) a modified value of the one or more payload values that are specific to the identity represented by the authenticated token;
a test-execution module configured to:
invoke each API with the first query and the one or more second queries, and
determine a plurality of test results for each API based on whether the API returns user data associated with the identity in response to each of the first query and the one or more second queries; and
a display module configured to cause display of an authorization measure for the collection of APIs that is based on the plurality of test results for each API.

7. The system of claim 6, wherein a given test result that corresponds to a given second query is a negative result based on the API returning the user data associated with the identity in response to the given second query, or a positive result based on the API returning an error in response to the given second query.

8. The system of claim 6, wherein the query-generation module is configured to generate a given second query based on:
selecting a second identity that is different from the identity represented by the authenticated token, and
replacing, in the given second query, one of the one or more payload values with a different value that is specific to the second identity, wherein the different value is the modified value.

9. The system of claim 6, wherein the display module is further configured to indicate, for a negative test result that corresponds to a given second query, (i) the identity represented by the authenticated token included in the given second query, and (ii) a second identity associated with the modified value included in the given second query.

10. The system of claim 6, wherein the test-execution module is configured to invoke each API within a particular environment that is indicated by testing metadata associated with each API.

11. The system of claim 6, further comprising a token-retrieval module configured to:
obtain the authenticated token from an identity provider that is associated with a service to which the collection of APIs belong, and
provide the authenticated token to the query-generation module.

12. The system of claim 6, wherein the test-execution module is configured to invoke each API and determine the plurality of test results for each API at a frequency indicated by testing metadata associated with each API.

13. The system of claim 6, wherein the collection of APIs are defined within a repository that sorts a plurality of collections of APIs according to respective platforms within which respective collections of APIs reside.

14. The system of claim 6, wherein the query-generation module is configured to, for a given query that is configured for a plurality of payload values, identify which payload values are user-specific values.

15. A system for authorization testing of APIs, the system comprising:
a service module configured to perform a function or task with input user data,
wherein the service module is associated with an API via which the input user data is provided to the service module;
an identity module configured to generate an authenticated token for a user identity;
a test module configured to:
invoke the API with a plurality of queries that each include the authenticated token for a given user identity,
wherein at least one particular query of the plurality of queries further includes an input value that is specific to a different user identity, and
store a plurality of test results corresponding to the plurality of queries and indicating whether or not the API returned an output of the service module in response to a respective query; and
a display module configured to cause display of an authorization measure of the API that is based on the plurality of test results.

16. The system of 15, wherein a particular test result that corresponds to the at least one particular query is a negative result based on the API returning the output of the service module, and wherein the particular test result is a positive result based on the API returning an error.

17. The system of 15, further comprising:
a repository module that defines a plurality of APIs in a hierarchy according to a respective service module of the system with which each API is associated.

18. The system of 15, wherein the API is associated with testing metadata that indicates an environment in which the test module invokes the API with the plurality of queries.

19. The system of 15, wherein the test module is configured to obtain the authenticated token from the identity module based on identifying the identity module as being associated with the service module out of a plurality of identity modules of the system.

20. The system of 15, further comprising a deployment module configured to, based on each of the plurality of test results being positive results, deploy the API for use with the service module.
